(19) United States
(12) Patent Application Publication
(10) Pub. No.: US 2026/0042437 A1
(43) Pub. Date: Feb. 12, 2026

(54) BRAKE ASSIST FOR HOLDING TORQUE WITHIN A BRAKE ASSEMBLY

(71) Applicant: Ford Global Technologies, LLC, Dearborn, MI (US)

(72) Inventors: Kenneth Patrick Mchugh, Canton, MI (US); Joshua Howell, Belleville, MI (US); Keith Weston, Canton, MI (US); Brendan Diamond, Naples, FL (US); Stuart C. Salter, White Lake, MI (US); Matthew Johnson, Toledo, OH (US)

(21) Appl. No.: 18/800,541

(22) Filed: Aug. 12, 2024

(51) Int. Cl. B60W 10/18

(52) U.S. Cl. CPC B60W 10/18; B60W 2420/403; B60W 2420/408

(57) ABSTRACT

A vehicle control system of a vehicle may include a first brake assembly to secure the vehicle in a stationary position while parked, a first sensor suite to monitor an environment outside the vehicle in response to the first brake assembly being enabled, a second sensor suite to monitor the environment, and a controller configured to monitor first sensor suite data received from the first sensor suite to determine potential vehicle movement. The controller may be configured to transition the vehicle to an awake state to enable the second sensor suite in response to determining the vehicle is moving, confirm the vehicle is moving via second sensor suite data received from the second sensor suite in response to the vehicle being in the awake state, and apply brake force from a second brake assembly in response to the vehicle being confirmed to be moving.

### TECHNICAL FIELD

Example embodiments generally relate to a vehicle control system and, more particularly, relate to a control system for determining when to apply an additional holding torque for a brake assist function.

### BACKGROUND

Steep parking grades, slippery parking surfaces, or inclement weather may cause a parked vehicle to experience a challenging parking environment. In presence of these conditions, vehicle operators may desire increased support for existing parking brakes to ensure expected parking performance. Thus, an additional brake assembly and vehicle control system to help identify challenging parking environments and apply braking torque within the wheel assemblies may be desired.

### BRIEF SUMMARY OF SOME EXAMPLES

In accordance with an example embodiment, a vehicle control system of a vehicle may be provided. The vehicle control system may include a first brake assembly to secure the vehicle in a stationary position while parked, a first sensor suite to monitor an environment outside the vehicle in response to the first brake assembly being actuated and the vehicle being in a sleep state, a second sensor suite that is disabled in response to the vehicle being in the sleep state, and a controller configured to monitor first sensor suite data received from the first sensor suite to determine potential vehicle movement. The controller may be configured to transition the vehicle to an awake state to activate the second sensor suite in response to determining the potential vehicle movement, confirm the vehicle is moving via second sensor suite data received from the second sensor suite in response to the vehicle transitioning to the awake state, and apply brake force from a second brake assembly in response to confirming the vehicle is moving.

In another example embodiment, a method for controlling a vehicle control system of a vehicle may be provided. The method may include securing the vehicle in a stationary position while parked via a first brake assembly, monitoring an environment outside the vehicle via a first sensor suite in response to the first brake assembly being actuated and the vehicle being in a sleep state, monitoring first sensor suite data via a controller configured to receive the first sensor suite data from the first sensor suite to determine potential vehicle movement. The method may further include transitioning the vehicle to an awake state to activate a second sensor suite that is inactive in the sleep state in response to determining the potential vehicle movement, confirming the vehicle is moving via second sensor suite data received from the second sensor suite in response to the vehicle transitioning to the awake state, and applying brake force from a second brake assembly in response to confirming the vehicle is moving.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts a block diagram of a vehicle control system of a vehicle in accordance with an example embodiment;

FIG. 2 illustrates a flow chart for a controller configuration for applying a second brake assembly in accordance with an example embodiment;

FIG. 3 depicts a flow chart for confirming potential vehicle movement in accordance with an example embodiment;

FIG. 4 illustrates a flow chart for an alternative controller configuration for applying a second brake assembly in accordance with an example embodiment; and

FIG. 5 depicts a method of a vehicle control system in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments described herein may address the issues described above. In this regard, for example, some embodiments may provide a parking brake assist to hold braking torque within the brake assembly. As a result, the addition of the parking brake assist may increase brake assembly performance.

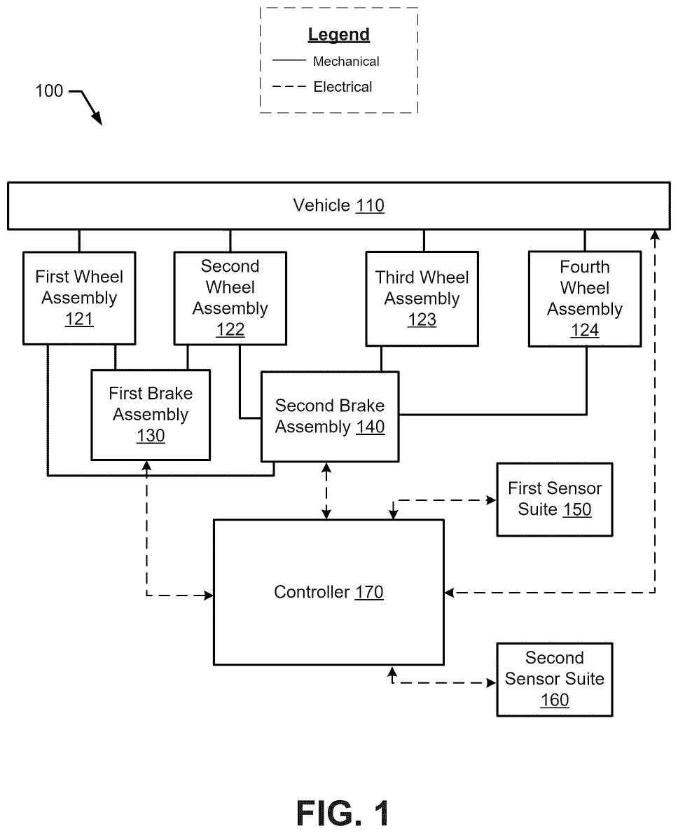

FIG. 1 depicts a block diagram of a vehicle control system of a vehicle in accordance with an example embodiment. As seen in FIG. 1, in some embodiments, the vehicle control system 100 of a vehicle 110 may include a one or more wheel assemblies. The number of wheel assemblies may vary depending on the vehicle 110. In some cases, the vehicle 110 may include four distinct wheel assemblies: a first wheel assembly 121, a second wheel assembly 122, a third wheel assembly 123, and a fourth wheel assembly 124. In an example embodiment, the first wheel assembly 121 and the second wheel assembly 122 may form a rear wheel assembly for the vehicle 110, and the third wheel assembly 123 and the fourth wheel assembly 124 may form a front wheel assembly for the vehicle 110.

The one or more wheel assemblies may include a tire, a rim, and various other wheel components. Each individual one of the one or more wheel assemblies may be operably coupled to the vehicle 110. In some cases, the one or more wheel assemblies may be operably coupled to an axle of the vehicle 110. In an example embodiment, the one or more wheel assemblies may be operably coupled to a suspension member of the vehicle 110.

In some cases, the vehicle 110 may include a chassis or frame. The chassis or frame may support and may form the foundation structure of the vehicle 110. In an example embodiment, the chassis and frame may be formed of one or more cast subframes, and a suspension member may be operably coupled to the chassis or frame to help operably couple the one or more wheel assemblies to the chassis or frame.

In some cases, the vehicle control system 100 and the vehicle 110 may include one or more brake assemblies. In an example embodiment, the one or more brake assemblies may include a first brake assembly 130 and a second brake assembly 140. The first brake assembly 130 and the second brake assembly 140 may be operably coupled to the one or more wheel assemblies. In some cases, the first brake assembly 130 and the second brake assembly 140 may be operably coupled to only specific ones of the one or more wheel assemblies. For example, the first brake assembly 130 may only be operably coupled to the first wheel assembly 121 and the second wheel assembly 122 (i.e. the rear wheel assembly of the vehicle 110). Furthermore, in an example embodiment, the second brake assembly 140 may be operably coupled to the first wheel assembly 121, the second wheel assembly 122, the third wheel assembly 123, and the fourth wheel assembly 124 (i.e. all the wheel assemblies present in the vehicle 110).

The first brake assembly 130 and the second brake assembly 140 may be a variety of different brake system types. For example, in some cases, the first brake assembly 130 and the second brake assembly 140 may be electronic brake boosted (EBB) braking systems, hydraulic brake systems, regenerative brake systems, other electronic brake systems, and any other brake system that may apply a brake force to the one or more wheel assemblies. In an example embodiment, the first brake assembly 130 may utilize one type of brake system, and the second brake assembly 140 may utilize a second type of brake mechanism. For example, the first brake assembly 130 may utilize primarily electronic brake systems, and the second brake assembly 140 may apply additional brake force via further EBB systems or other electronic brake mechanisms.

In an example embodiment, the first brake assembly 130 and the second brake assembly 140 may be operably coupled to the one or more wheel assemblies via mechanical and/or electrical operable coupling. In some cases, the first brake assembly 130 and the second brake assembly 140 may be electrically operably coupled to a controller 170. In an example embodiment, the controller 170 may include one or more controllers. The controller 170 may include processing circuitry that includes a processor and memory. The processing circuitry may be configured to provide electronic control of the inputs to one or more functional units of the vehicle control system 100 and to process data received at or generated by the one or more functional units of the vehicle control system. Thus, the processing circuitry may be configured to perform data processing, control function execution and/or other processing and management services according to an example embodiment. In some embodiments, the processing circuitry may be embodied as a chip or chip set. In other words, the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry may therefore, in some cases, be configured to implement an embodiment of the present invention on a single chip or as a single “system on a chip.” As such, in some cases, a chip or chipset may constitute means for performing one or more operations for providing the functionalities described herein. In an example embodiment, other vehicle control modules may include similar processing circuitry.

The controller 170 may be operably coupled to the first brake assembly 130, second brake assembly 140, and other vehicle components via a variety of methods. The controller 170 may utilize wired or wireless communications to communicate and receive information from vehicle components. In some cases, the controller 170 may receive information from other vehicle control modules connected to the first brake assembly 130, second brake assembly 140, and other vehicle components. In an example embodiment, the first brake assembly 130, the second brake assembly 140, and other vehicle components may include separate controllers or control modules that may communicate with the controller 170.

In some cases, the other vehicle components may include one or more sensor suites. The one or more sensor suites may include a variety of different sensors and/or detectors that provide information regarding the vehicle 110 and its surroundings/environment. In an example embodiment, the vehicle control system 100 may include a first sensor suite 150 and a second sensor suite 160. The first sensor suite 150 and the second sensor suite 160 may include a plurality of different sensors monitoring vehicle conditions and surface conditions around the vehicle 110. The vehicle conditions may be monitored by the first sensor suite 150 and the second sensor suite 160 via wheel sensors, external cameras/radars monitoring vehicle movement, vehicle attachment sensors (i.e. trailer attachment sensor), brake temperature sensors, or any number of sensors that help to determine the vehicle conditions. The surface conditions may be the current conditions or estimated future conditions of the surface where the vehicle is parked. Surface conditions may be monitored by the first sensor suite 150 and the second sensor suite 160 via temperature sensors, parking grade estimators, location/GPS sensors, external weather reports, external cameras monitoring the surface, or any number of sensors that help to determine the surface conditions.

In an example embodiment, the first sensor suite 150 and the second sensor suite 160 may share some of the plurality of sensors. In an example embodiment, the first sensor suite 150 and the second sensor suite 160 may include one or more cameras. The one or more cameras may be disposed around the vehicle 110 to view the environment around the vehicle 110. In some cases, the one or more cameras are existing cameras of the vehicle 110. For example, a one or more cameras may include a dash camera, a backup camera, a canopy camera, or any other vehicle camera that views the environment around the vehicle 110. In an example embodiment, the one or more cameras may provide a 360-degree view of the environment surrounding the vehicle 110. However, more limited fields of view are also possible and may be sufficient for operation of example embodiments in some situations.

In some cases, the first sensor suite 150 may primarily include one or more proximity detection sensors. In some cases, the one or more proximity detection sensors may include the one or more cameras. In an example embodiment, the one or more proximity detection sensors may include a radar sensor, a received signal strength indicator (RSSI) sensor, or a Time-of-Flight sensor. In some cases, the radar sensor may be an ultra-wideband (UWB) radar sensor and/or multiple existing radar sensors. For example, the vehicle control system 100 may include one or more of a canopy radar, a blind spot radar, a parking assist radar, and an adaptive cruise radar. The multiple existing radar sensors may serve a dual-purpose and help assist the controller 170 in determining potential vehicle movement while the vehicle 110 is asleep (e.g., in a reduced activity mode in which one or more sensors or other functional units of the vehicle 110 are disabled temporarily to conserver power or resources). An RSSI sensor may use received signal strength to determine proximity to surrounding objects that transmit signals, and a Time-of-Flight sensor may use received returns from emissions to determine distances to objects based on the round trip time-of-flight after the emissions bounce of the objects. In an example embodiment, the first sensor suite 150 may include a global positioning system (GPS) sensor. In some cases, location data may be transmitted from the GPS to the controller 170 to assist in potential vehicle movement determination and general vehicle location determination.

In an example embodiment, the second sensor suite 160 may include the wheel speed sensors, external cameras/radars monitoring vehicle movement, vehicle attachment sensors (i.e. trailer attachment sensor), brake temperature sensors, or any number of sensors that help to determine the vehicle conditions. In some cases, the second sensor suite 160 may not operate until a condition is detected/determined by the first sensor suite 150 and the controller 170. In other words, only the first sensor suite 150 may be active when the vehicle 110 is in the sleep state, whereas the second sensor suite 160 may become active when the vehicle 110 transitions from the sleep state to an awake state. For example, while the vehicle 110 is in the sleep state, the condition that may be determined by first sensor suite data provided by the first sensor suite 150 to the controller 170 may indicate there is potential vehicle movement. Potential vehicle movement may be determined by the controller 170 configured to interpret data received from the proximity detection sensors, and may trigger a transition to the awake state, thereby activating the second sensor suite 160, which will then provide second sensor suite data to the controller 170 to enable the controller 170 to confirm (or deny) that the vehicle 110 is actually moving. If the vehicle 110 is indeed determined to be moving, further action may be taken by the controller 170 including the provision of additional brake force by the second brake assembly 140.

Accordingly, for example, the first brake assembly 130 may apply normal parking brake torque to two wheels (e.g., the first and second wheel assemblies 121 and 122) while the vehicle 110 is in the sleep state and the first sensor suite 150 may operate in a relatively low power mode to detect potential vehicle movement. If the potential vehicle movement is detected, the vehicle 110 may transition to the awake state and the second sensor suite 160 may be brought on line (i.e., activated) to confirm whether there is actual movement of the vehicle 110 with expanded sensor equipment. If there is actual movement, then the second brake assembly 140 may be used to actuate brake force (e.g., additional holding brake force) at all four of the wheels.

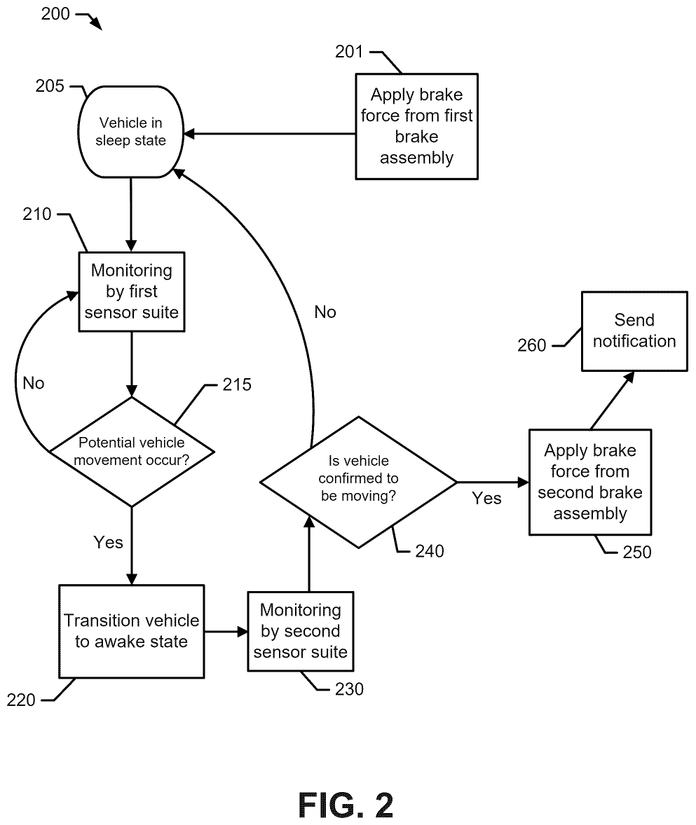

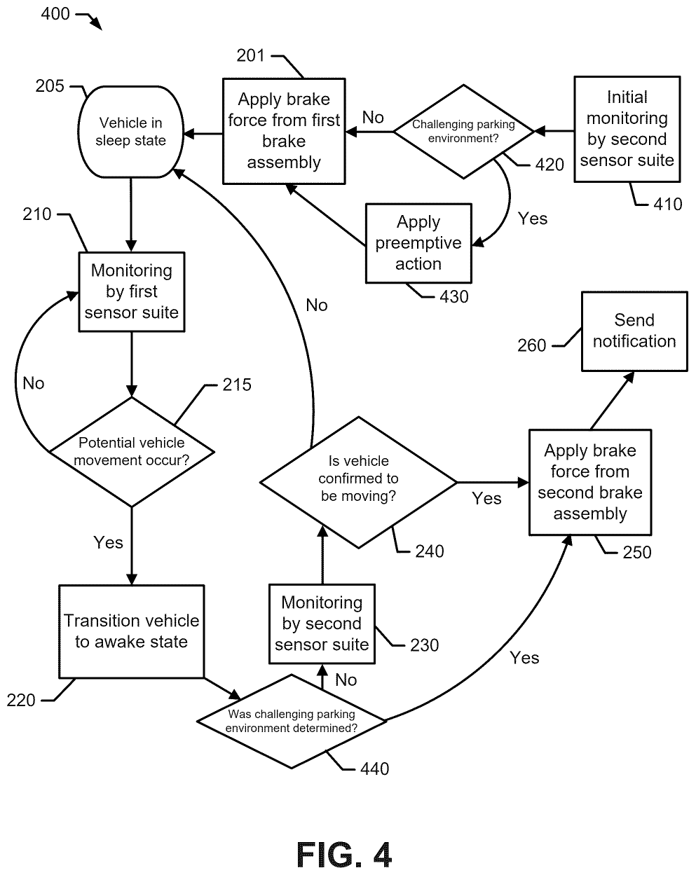

FIG. 2-4 depict flow charts according to example embodiments that further define how the vehicle control system 100 may operate in an example embodiment. For example, within a standard parking environment, the vehicle control system 100 may follow process 200. In some cases, process 200 of the vehicle control system 100 may begin with applying brake force from the first brake assembly 130 to the first wheel assembly 121 and the second wheel assembly 122 at operation 201. In an example embodiment, the brake force applied by the first brake assembly 130 may be considered parking brake force, and the first brake assembly 130 may be considered a parking brake. In some cases, the first brake assembly 130 may apply the braking force responsive to action of a vehicle operator or automatically upon transitioning the vehicle 110 into park or into the parked state.

Responsive to the first brake assembly 130 applying brake force at operation 201, the vehicle 110 may enter a sleep state. In some cases, the vehicle 110 may enter the sleep state directly responsive to operation 201. In an example embodiment, the vehicle 110 may enter the sleep state responsive to the vehicle's ignition being turned off after the first brake assembly 130 applies the brake force. The vehicle 110 may enter the sleep state at operation 205 responsive to an input from an operator while the vehicle's ignition is still running.

In an example embodiment, responsive to the vehicle 110 being in the sleep state, the vehicle control system 100 may monitor the environment around the vehicle 110 using the first sensor suite 150 at operation 210. The first sensor suite 150 may operate in the background, along with the controller 170, while the vehicle 110 is in the sleep state. The first sensor suite 150, as well as the controller, may have low power requirements or low power modes as to limit battery consumption while operating while the vehicle 110 is in the sleep state. For example, the first sensor suite 150 may only include one or more proximity detection sensors and/or one or more cameras.

The first sensor suite 150 may then determine if potential vehicle movement is occurring at operation 215. In an example embodiment, the proximity detection sensors and/or the one or more cameras of the first sensor suite 150 may collect first sensor suite data to transmit to the controller 170. The controller 170 may utilize the first sensor suite data to determine if potential vehicle movement occurs via comparing the first sensor suite date to past sensor suite data. For example, if the radar data received from the first sensor suite 150 indicates relative movement of one or more objects nearby the vehicle 110, the controller 170 may determine potential vehicle movement has occurred. If the controller 170 determines potential vehicle movement has not occurred, the vehicle control system 100 may return to operation 210 and continue monitoring the environment with the first sensor suite 150.

Responsive to determining potential vehicle movement has occurred at operation 215, the vehicle 110 may transition to an awake state as operation 220. Responsive to operation 220, the vehicle control system 100 may monitor the environment utilizing the second sensor suite 160 to confirm if the vehicle is moving. In an example embodiment, the second sensor suite 160 may include one or more cameras monitoring the outside of the vehicle 110, wheel speed sensors, vehicle incline sensors, and any other available vehicle sensor that may help confirm if the vehicle is moving.

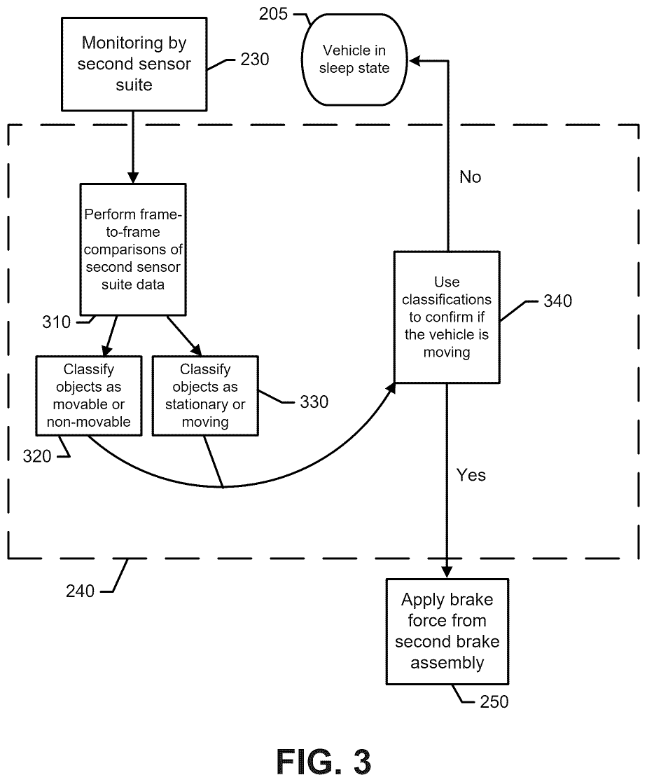

FIG. 3 expands on how the controller 170 may confirm potential vehicle movement using cameras. However, similar conceptual practices may be performed with respect to other sensor data. In some cases, the one or more cameras of the second sensor suite 160 may share real-time data with the controller 170. The controller 170 may then make frame-to-frame comparisons of the second sensor suite data to help confirm if the vehicle 110 is moving in operation 310. In an example embodiment, the frame-to-frame comparisons may determine if the pixels of the second sensor suite data change frame-to-frame. In some cases, the percentage of pixel change may help the controller 170 confirm the vehicle 110 is moving. For example, if over 50% of the pixels are changing frame-to-frame, the controller 170 may confirm the vehicle 110 is moving and not experiencing a false positive caused by singular moving objects around the vehicle 110. In an example embodiment, the percentage of pixel change may by closer to 80% or 90% depending on sensitivity desired.

In some cases, the controller 170 may be configured to further classify objects using the frame-to-frame comparisons of second sensor suite data in operation 310. The classification of objects may use pixel data taken from the one or more cameras of the second sensor suite 160. In some cases, the classification of objects by the controller 170 may classify objects in the environment surrounding the vehicle 110 a variety of different ways. One potential classification strategy may be to classify objects as movable or non-movable in operation 320. For example, a tree may be classified as non-movable, and parked vehicle may be classified as movable. The classification of objects as movable or non-movable may help the controller 170 determine if the vehicle 110 is moving via understanding if an object is expected to move or not. In this case, for example, other vehicles pulling out of parking spaces may not be trigger a false positive for confirming the vehicle 110 is moving. The controller 170 may utilize the classification of operation 320 to further confirm if the vehicle is moving in operation 340.

In an example embodiment, another potential classification performed by the controller during operation 240 to help confirm if the vehicle 110 is moving is the classification of objects as stationary or moving in operation 330. The classification in operation 330 of objects as stationary or moving may occur in real time and automatically by the controller 170. The classification in operation 330 may occur via frame-to-frame pixel analysis. Classification of an object as stationary may occur if the position of an object has not changed after a threshold number of frames or a threshold amount of time has passed. The specific thresholds may be variable based on sensed conditions around the vehicle 110 or may be predetermined. In some cases, the threshold number of frames may be between 10-20 frames and the threshold amount of time may be between 0.5-1.5 seconds. The controller 170 may utilize the classification of operation 330 to further confirm if the vehicle is moving in operation 340.

In an example embodiment, the classification of objects as movable or non-movable in operation 320 and the classification of objects as stationary and movable in operation 330 may occur concurrently or sequentially and the controller 170 may use the classifications together to confirm if the vehicle 110 is moving. For example, the controller 170 may utilize the classification of a tree as non-movable object in operation 320 and the classification of the tree as a moving object in operation 330 to confirm the vehicle 110 is moving. To the contrary, in a further example, the controller 170 may utilize the classification of a parked car as movable object in operation 320 and the classification of the parked car as a moving object in operation 330 to prevent a potential false positive to confirm the vehicle 110 is not moving or that the controller 170 needs to perform further analysis. In some cases, the classification in operations 320 and 330 may be combined with further classification operations/techniques, further frame-to-frame comparisons (i.e. pixel change percentage, etc.), and other second sensor suite data to help confirm if the vehicle 110 is moving.

In some cases, the other second sensor suite data may include wheel speed data from the wheel assemblies. In an example embodiment, the other second sensor suite data can include vehicle inclination data, parking surface inclination data, weather data, vehicle location data, vehicle speed data, brake temperature data, and/or any other data collected from the second sensor suite that may assist in the confirmation of if the vehicle 110 is moving.

In some cases, the controller 170 may use only one classification of object performed in operations 320 and 330 in operation 340 to confirm if the vehicle is moving. In an example embodiment, the controller 170 may ignore both classifications in operations 320 and 330, as well as the entire data from the one or more camera, if the data appears unreliable or is unclear. For example, controller 170 may only utilize the other second sensor suite data to confirm if the vehicle 110 is moving if the one or more cameras are covered or occluded.

If the controller 170 confirms the vehicle 110 to be moving in operation 340, the vehicle control system 100 may apply brake force from the second brake assembly 140 to all of the wheel assemblies to prevent further vehicle movement at operation 250. Responsive to application of brake force from the second brake assembly 140, the vehicle control system 100 may send a notification. In some cases, the vehicle control system 100 may send the notification via a transmission or communication module of the controller 170. In an example embodiment, the notification may be a local notification to the vehicle or a remote notification to an external device. The local notification may include notification utilizing existing vehicle components. For example, the notification in operation 260 may include flashing indicator lights and headlights of the vehicle 110 and/or sounding the alarm/horn of the vehicle 110. The remote notification to an external device may include a notification to the operator's mobile device or computer. In some cases, the remote notification may include a live or past video feed of the vehicle 110 to highlight the vehicle movement. In an example embodiment, the remote notification may include a series of pictures or still frames taken from the one or more cameras. In some cases, the controller 170 may send both local notifications and remote notifications in operation 260 after application of brake force from the second brake assembly 140.

If the controller 170 confirms the vehicle is not moving in operation 340, the vehicle control system 100 may transition the vehicle 110 back to the sleep state in operation 205. Responsive to transition of the vehicle 110 back to the sleep state, the vehicle control system 100 may continue to monitor the environment surrounding the vehicle 110 via the first sensor suite 150 (and the second sensor suite 160 may be deactivated). In some cases, the vehicle control system 100 may perform diagnostics as to why potential vehicle movement was previously determined in operation 215. The vehicle control system 100 may use diagnostics to prevent future false positives to help conserve vehicle battery life. Additionally, the vehicle control system 100 may also perform diagnostics responsive to sending notifications in operation 260. In an example embodiment, diagnostics may include monitoring currently applied brake force from the second brake assembly 140 after operation 250. In some cases, the brake force or brake torque of the second brake assembly 140 may have reduced magnitude after the second brake assembly 140 stops vehicle movement to further limit battery consumption.

In an example embodiment, within a challenging parking environment, the vehicle control system 100 may follow process 400. For example, in process 400, the vehicle control system 100 may also utilize the second sensor suite 160 prior to the vehicle 110 transitioning into the sleep state in operation 205 to determine if the vehicle 110 is in a challenging parking environment via monitoring the environment around the vehicle 110 in operation 410. In some cases, the monitoring the environment around the vehicle 110 via the second sensor suite 160 in operation 410 may occur before or after the application of brake force from the first brake assembly in operation 201. Responsive to the initial monitoring by the second sensor suite, the controller 170 and vehicle control system 100 may determine if the vehicle 110 is located in challenging parking environment in operation 420 via the initial second sensor suite data. The initial second sensor suite data may be data collected from a variety of vehicle sensors, including but not limited to parking surface grade/inclination, parking surface coefficient of friction (μ), historical location data, vehicle location data, future weather forecast, covered/uncovered parking data, and present weather data (precipitation data, temperature data, etc.).

In some cases, the vehicle 110 may be determined to be in a challenging parking environment in operation 420 if the μ value of the parking surface is below a certain threshold and/or of the parking surface grade/inclination is above a certain threshold. The threshold values may be determined via an initial calibration based on vehicle model. The controller 170 may use vehicle location to determine if the vehicle 110 may be in a challenging parking environment via historical data from current vehicle 110 or other vehicles. If the vehicle 110 is determined to be located in historically challenging parking environment or location, the controller 170 may recommend finding an alternative parking location. In an example embodiment, the controller 170 may adjust the threshold values for determination of a challenging parking environment based on other sensor data or information. For example, if the controller 170 determines the vehicle 110 is parked on a historically challenging parking environment, the μ value and/or parking surface grade/inclination thresholds may be reduced to account for the location. In some cases, an estimate of the μ value may be made while the vehicle 110 is in the awake state using all vehicle sensors (i.e., both the first and second sensor suites 150 and 160) prior to going asleep via measurement of slip values, detecting precipitation, determining surface incline, etc. The estimate of the μ value may then be used to determine whether the vehicle 110 is in the challenging parking environment prior to going asleep and powering down or deactivating the second sensor suite 160.

Responsive to determining a challenging parking environment is present, the vehicle control system 100 may apply preemptive action to the vehicle 110 in operation 430. In some cases, the preemptive action may include rotating the one or more wheel assemblies (i.e. rotate wheel assemblies of steerable wheels towards a curb), changing the vehicle mode (i.e. 4×4 or 4 Lo transition, engaging a lower gear, etc.), reducing tire pressure, engaging additional wheel locks, and/or changing the vehicle parking mode. In some cases, the preemptive actions may also include recommending wheel chocks be placed behind the wheel assemblies prior to the operator leaving the vehicle's location. In an example embodiment, the preemptive actions may apply to the vehicle control system 100 after application of braking force from the second brake assembly 140 in operation 250.

After applying preemptive actions at operation 430, the vehicle control system 100 may continue to operation 201 and/or operation 205. Responsive to detecting potential vehicle movement in operation 215 and waking up the vehicle 110 in operation 220, if the vehicle 110 was determined to be in a challenging parking environment in operation 420, the vehicle control system 100 may preemptively apply brake force from the second brake assembly 140 at operation 250 rather than confirming the vehicle is moving at operation 440. In this regard, the vehicle control system 100 may save time in the actuation of the second brake assembly 140 in the challenging parking environment. In some cases, the vehicle 110 may additionally engage a double-pull to impede door movement responsive to applied brake force from the second brake assembly 140 to encourage the operator and/or any passengers to stay in the car. If a challenging parking environment is not present after operation 420, the vehicle control system 100 may follow the typical methodology outlined in FIG. 2

In some cases, the vehicle control system 100 may double back after preemptively applying the brake force for the second brake assembly 140 in response to operation 440 to confirm if the vehicle 110 is moving in operation 240. For example, concurrently with sending a notification in operation 260, the vehicle control system 100 may also confirm if the vehicle 110 is moving in operation 240. In an example embodiment, the notification sent in operation 260 may include confirmation of if vehicle control system 100 confirms the vehicle 110 to be moving.

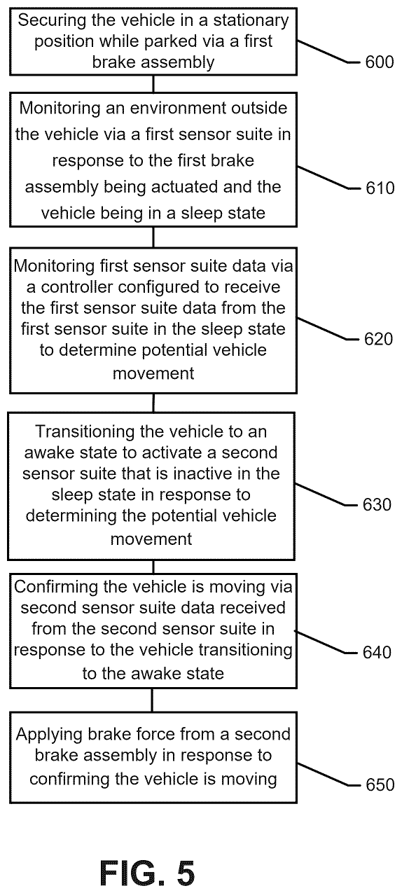

FIG. 5 illustrates a block diagram of a method for determining and stopping potential vehicle movement in accordance with an example embodiment. The method may include securing the vehicle in a stationary position while parked via a first brake assembly at operation 600. The method may further include monitoring an environment outside the vehicle via a first sensor suite in response to the first brake assembly being actuated and the vehicle being in a sleep state at operation 610. The method also may include monitoring first sensor suite data via a controller configured to receive the first sensor suite data from the first sensor suite in the sleep state to determine potential vehicle movement at operation 620. In an example embodiment, the method may include transitioning the vehicle to an awake state to activate a second sensor suite that is inactive in the sleep state in response to determining the potential vehicle movement at operation 630. The method may further include confirming the vehicle is moving via second sensor suite data received from the second sensor suite in response to the vehicle transitioning to the awake state at operation 640. Finally, the method may include applying brake force from a second brake assembly in response to confirming the vehicle is moving at operation 650.

A vehicle control system of a vehicle may therefore be provided. The vehicle control system may include a first brake assembly to secure the vehicle in a stationary position while parked, a first sensor suite to monitor an environment outside the vehicle in response to the first brake assembly being actuated and the vehicle being in a sleep state, a second sensor suite that is disabled in response to the vehicle being in the sleep state, and a controller configured to monitor first sensor suite data received from the first sensor suite to determine potential vehicle movement. The controller may be configured to transition the vehicle to an awake state to activate the second sensor suite in response to determining the potential vehicle movement, confirm the vehicle is moving via second sensor suite data received from the second sensor suite in response to the vehicle transitioning to the awake state, and apply brake force from a second brake assembly in response to confirming that the vehicle is moving.

The vehicle control system of a vehicle of some embodiments may include additional features, modifications, augmentations and/or the like to achieve further objectives or enhance performance of the suspension assembly. The additional features, modifications, augmentations and/or the like may be added in any combination with each other. Below is a list of various additional features, modifications, and augmentations that can each be added individually or in any combination with each other. For example, the first brake assembly may apply braking torque to two wheels of the vehicle when actuated, and the second brake assembly may apply braking torque to all wheels of the vehicle when applied. In an example embodiment, the first sensor suite may include a proximity detection sensor, and the proximity detection sensor may be a radar sensor, a received signal strength indicator (RSSI) sensor, or a Time-of-Flight sensor. In some cases, the second sensor suite may include one or more cameras disposed around the vehicle to provide image data showing a view of the environment. In an example embodiment, the one or more cameras may be disposed around the vehicle include existing vehicle camera systems, and the existing vehicle camera systems may include a dash camera, a backup camera, and a canopy camera. In some cases, the controller may utilize the one or more cameras to confirm the vehicle is moving via frame-to-frame comparisons of the environment to detect movement of the vehicle relative to the environment. In an example embodiment, the controller may be configured to determine a classification of objects as movable or non-moveable. In some cases, the controller may be configured to determine the classification of objects as stationary or moving using the frame-to-frame comparisons, and the objects may be classified as stationary when a position of the objects have not changed after a threshold number of frames or a threshold amount of time. In an example embodiment, the controller may be configured to utilize the classification of objects to determine if the vehicle is moving. In some cases, the second sensor suite may include a camera, parking surface angle sensor, wheel speed sensor, weather sensor, or location sensor. In an example embodiment, responsive to the vehicle being in an awake state prior to transitioning to the sleep state, the controller may be configured to utilize the second sensor suite to determine if the vehicle is in a challenging parking environment. In some cases, responsive to determining the vehicle is in the challenging parking environment, the controller may be configured to preemptively apply brake force from the second brake assembly in response to the first sensor suite determining the vehicle is moving prior to the confirming the vehicle is moving via second sensor suite data. In an example embodiment, responsive to determining the vehicle in in the challenging parking environment, the controller may be configured to apply preemptive actions to decrease a likelihood of vehicle movement while parked. In some cases, the preemptive actions may include turning wheels a specific direction prior to parking or applying external wheel locking mechanisms. In an example embodiment, the preemptive actions may include rotating wheels a specific direction prior to parking or applying external wheel locking mechanisms. In some cases, responsive to confirming the vehicle is moving via second sensor suite data, the controller may be configured to send a notification. In an example embodiment, the notification may be a local notification to the vehicle or remote notification to an external device. In some cases, the local notification may be an auditory or visual notification generated at the exterior of the vehicle. In an example embodiment, the remote notification may include current vehicle state information transmitted to the external device.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to issues are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A vehicle control system of a vehicle, the vehicle control system comprising:
a first brake assembly to secure the vehicle in a stationary position while parked,
a first sensor suite to monitor an environment outside the vehicle in response to the first brake assembly being actuated and the vehicle being in a sleep state;
a second sensor suite that is disabled in response to the vehicle being in the sleep state; and
a controller configured to monitor first sensor suite data received from the first sensor suite to determine potential vehicle movement, the controller further configured to:
transition the vehicle to an awake state to activate the second sensor suite in response to determining potential vehicle movement,
confirm the vehicle is moving via second sensor suite data received from the second sensor suite in response to the vehicle transitioning to the awake state, and
apply brake force from a second brake assembly in response to confirming that the vehicle is moving.

2. The vehicle control system of claim 1, wherein the first brake assembly applies brake torque to two wheels of the vehicle when actuated, and
the second brake assembly applies brake torque to all wheels of the vehicle when applied.

3. The vehicle control system of claim 1, wherein the first sensor suite includes a proximity detection sensor, and
wherein the proximity detection sensor is a radar sensor, a received signal strength indicator (RSSI) sensor, or a Time-of-Flight sensor.

4. The vehicle control system of claim 1, wherein the second sensor suite includes one or more cameras disposed around the vehicle to provide image data of the environment.

5. The vehicle control system of claim 4, wherein the one or more cameras are disposed around the vehicle include a dash camera, a backup camera, or a canopy camera.

6. The vehicle control system of claim 4, wherein the controller utilizes the one or more cameras to confirm the vehicle is moving via a frame-to-frame comparison of image data of the environment to detect movement of the vehicle relative to the environment.

7. The vehicle control system of claim 6, wherein the controller is configured to determine a classification of an object in the environment as movable or non-moveable based on the frame-to-frame comparison.

8. The vehicle control system of claim 7, wherein the object is classified as stationary when a relative position of the object has not changed after a threshold number of frames or a threshold amount of time.

9. The vehicle control system of claim 8, wherein the controller is configured to utilize the classification of the object to determine if the vehicle is moving.

10. The vehicle control system of claim 1, wherein the second sensor suite includes a camera, parking surface angle sensor, wheel speed sensor, weather sensor, or location sensor.

11. The vehicle control system of claim 1, wherein responsive to the vehicle being in the awake state prior to transitioning to the sleep state, the controller is configured to utilize the second sensor suite to determine if the vehicle is in a challenging parking environment.

12. The vehicle control system of claim 11, wherein responsive to determining the vehicle is in the challenging parking environment, the controller is configured to preemptively apply brake force from the second brake assembly in response to the first sensor suite determining the vehicle is moving prior to the confirming the vehicle is moving via the second sensor suite data.

13. The vehicle control system of claim 11, wherein responsive to determining the vehicle in in the challenging parking environment, the controller is configured to apply a preemptive action to decrease a likelihood of vehicle movement while parked.

14. The vehicle control system of claim 13, wherein the preemptive action includes rotating wheels a specific direction prior to parking or applying external wheel locking mechanisms.

15. The vehicle control system of claim 1, wherein responsive to confirming the vehicle is moving via the second sensor suite data, the controller is configured to send a notification.

16. The vehicle control system of claim 15, wherein the notification is a local notification at the vehicle or remote notification to an external device.

17. The vehicle control system of claim 16, wherein the local notification is an auditory or visual notification generated at the vehicle.

18. The vehicle control system of claim 16, wherein the remote notification includes current vehicle state information transmitted to the external device.

19. A method for controlling a vehicle control system of a vehicle, the method comprising:
securing the vehicle in a stationary position while parked via a first brake assembly,
monitoring an environment outside the vehicle via a first sensor suite in response to the first brake assembly being actuated and the vehicle being in a sleep state;
monitoring first sensor suite data via a controller configured to receive the first sensor suite data from the first sensor suite in the sleep state to determine potential vehicle movement;
transitioning the vehicle to an awake state to activate a second sensor suite that is inactive in the sleep state in response to determining the potential vehicle movement;
confirming the vehicle is moving via second sensor suite data received from the second sensor suite in response to the vehicle transitioning to the awake state; and
applying brake force from a second brake assembly in response to confirming the vehicle is moving.

20. The method of claim 19, wherein responsive to confirming the vehicle is moving via the second sensor suite data, sending a notification,
wherein the notification is a local notification at the vehicle or remote notification to an external device.
